(19) United States
(12) Patent Application Publication
(10) Pub. No.: US 2011/0297068 A1
(43) Pub. Date: Dec. 8, 2011

(54) UNIVERSAL DEPTH BOAT

(75) Inventor: Paul Willging, Albany, IL (US)

(73) Assignee: PHOWLER BOAT COMPANY, INC., Clinton, IA (US)

(21) Appl. No.: 13/189,882

(22) Filed: Jul. 25, 2011

Related U.S. Application Data
(63) Continuation of application No. 12/258,676, filed on Oct. 27, 2008.
(60) Provisional application No. 61/000,545, filed on Oct. 27, 2007.

(51) Int. Cl. B63B 1/06; B23P 11/00; B63B 1/22; B63B 1/08; B63B 3/38

(52) U.S. Cl. 114/285; 114/61.33; 29/428

(57) ABSTRACT

The various embodiments disclosed and pictured herein illustrate a universal depth boat that is easy to operate and may be controlled by a single operator. A universal depth boat and hull design that comprises a hull having a bow, stern, sides, a V-hull portion and a flat bottom is disclosed. In the exemplary embodiment, a V-hull portion for spreading water is centrally located at a forward portion of the watercraft. The V-hull portion may include a keel as a forward apex, which forms a substantially perpendicular or vertical leading wedge with respect to the plane of water. The V-hull portion transitions to a flat bottom toward the stern. Accordingly, the watercraft will more easily traverse waves instead of riding over them, while the watercraft is simultaneously capable of accessing areas with extremely shallow water.

### CROSS-REFERENCE TO RELATED APPLICATIONS

This application is a Continuation Application of U.S. Ser. No. 12/258,676 filed Oct. 27, 2008, which claims priority under 35 U.S.C. §119 to provisional application Ser. No. 61/000,545 filed on Oct. 27, 2007, herein incorporated by reference in their entirety.

### FIELD OF THE INVENTION

The present invention relates generally to watercraft. More specifically, the present invention relates to watercraft hulls designed to displace water in a manner to provide enhanced stability and movement through the water while simultaneously allowing the watercraft to operate in extremely shallow water.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### BACKGROUND OF THE INVENTION

Conventional recreational and commercial watercrafts, for the most part, incorporate hulls that have V-shaped bottoms, with the V-shape forming a keel at its lowest point. The V-shape is thought to enable the boat, as speed is increased, to be pushed upwardly out of the water, as the water traversing against the boat's bow is forced sideways and downwardly at a vector to the outer shape of the hull. Such designs have been used for years, but have various deficiencies.

One detriment to such hull designs is that the draft of the boat tends to sit relatively deep in the water in relation to the length and beam of the boat, thus requiring sufficient depth of water to accommodate that draft. Another detriment to such hull designs is that they require a relatively large amount of force (and horsepower) to propel such a boat forward at a sufficient speed to stabilize the boat, i.e., to force the water sideways and downwardly as the boat travels generally horizontally through the water.

With V-shaped hull designs, initially, as velocity begins to increase from zero the bow of the boat acts much like a plow, digging into and through the surface of the water. This creates what is known as a “bow wave”. As velocity increases, the bow tends to be forced upwardly by the sideways and downward force being applied to the water by the curvature of the V-shape of the hull, which is being forced horizontally forward and up over the bow wave.

Finally, when sufficient velocity is reached, the apex of the force on the V-shaped hull travels aftwardly along the hull, forcing the boat more upwardly to an increasing degree until a point is reached at which the bow, now out of the water, tends (by force of gravity) to descend toward the water, pivoting on the apex of the force against the sides and bottom of the V-shaped hull. This pivoting serves to raise the stern of the boat as the bow descends until the whole boat is lifted upwardly into what is known as a planing position. At this point, because there is relatively less water contacting the hull, drag from that water is reduced and the boat is correspondingly able travel at a significantly greater speed given the same amount of force propelling the boat forward.

Of course, as might be anticipated, the hydraulic force of the water against the V-shaped hull is substantial, and thus at least an equally substantial counteracting force must be provided by the engine of the boat. Significant power is required to get the boat up to the planing position and to maintain it there. The ultimate speed of the boat when planing depends on the specific design of the V-shaped hull, the weight (and weight distribution) of the boat, and the available power (i.e., the size of the engine and the size and pitch of the propeller that is driven by the engine). However, in all cases, the forward movement of the boat at any speed, whether planing or not, is counteracted by both crossways and downward vectors of force produced by the relative hydraulic movement of the water against the hull.

The amount of fuel needed to power a boat at a given velocity is in direct proportion to the overall degree of each of the forces that must be overcome to move that boat forward over a given distance. The greater those forces, the greater the amount of fuel required. Thus, as a general proposition, if fuel economy is a concern, hull designs that tend to reduce the overall amount of opposing forces directed against the hull during forward movement of the boat are desirable. One approach to mitigate fuel usage is the use of relatively flat bottom hulls wherein there is less counteracting hydraulic force imposed against the hull as the boat moves forward. A flat hull is more readily pushed directly up over the bow wave to a position substantially on top of the water, creating less displacement of water by the hull in the dynamic mode as distinguished from the static mode. In other words, dynamic displacement of water is significantly less with a flat bottom boat than with a V-shaped bottom. On the other hand, static displacement, when the boat is at rest, is substantially the same for a flat bottom or a V-bottom boat, given equivalent boat weights and hull-surface contact area with the water.

Watercraft or boats with flat bottom hulls have been known for years. Small fishing boats have been manufactured using this design. Such boats have a relatively shallow draft to enable sports fishermen or hunters to reach shallow waters along shorelines, shallow and swampy areas, and lakes, ponds, and/or streams that are not sufficiently deep to accommodate the draft of conventional V-bottom boats.

Such designs have evolved into what are popularly called “bass boats”. Bass boat hulls are relatively narrow, in relation to length, with generally flat bottoms and relatively shallow V-shapes, if any. The draft of these boats is relatively shallow in comparison to V-shaped hulls. Once up on a plane, the vector force of the water is mostly downward, forcing these boats to rise up out of the water to a greater degree at relatively slower speeds. Accordingly, ultimate velocity may be greater, and relatively less engine power may be required to reach a given velocity.

One disadvantage to bass boat hulls is that because bass boats are relatively narrow beamed and there is relatively little crossways or lateral force exerted against the hull of a bass boat, there is correspondingly less lateral stability; and, due to a relatively narrow beam, such boats tend to be susceptible to laterally moving waves. Also, these flat bottom hulls are also generally more susceptible to waves as the hull rides more on top of the waves rather than slicing through waves as V-shaped hulls do to a greater degree. Furthermore, flat-bottomed boats do not steer as easily or as precisely as those with distinct, V-shaped hulls, again due to the fact that such boats incur relatively less opposing crossways forces (which are the forces that tend to hold a boat to a straight forward movement). Opposing crossways forces, if present, may be precisely altered by a rudder device at the stern. Therefore, most bass boats tend to skid laterally sideways more readily during turning, thus making turning a much less precise and controllable skidding action rather than the positive, more precisely controllable action of V-shaped hulls. Bass boat designs rarely incorporate sponsons, thus, for the sake of safety it is almost necessary to slow some high-powered bass boats down before turning, to both achieve a more precise turn and to prevent the boat from flipping over.

Both types of hulls are susceptible to wave action and may produce instability depending on the height and direction of waves. Both types of hulls have large surfaces which absorb the force of waves and cause significant vibration, vertical or lateral movement, or a combination thereof. Other boats include hull designs which incorporate pontoons or sponsons for lateral stability and floatation, but such systems are undesirable for a number of reasons. Published U.S. Pat. Application No. 20070157865 filed by Baker and entitled “Watercraft with Wave Deflecting Hull” and U.S. Pat. No. 6,425,341 issued to Devin entitled “Boat Hull” provide more pertinent background on the prior art and are incorporated by reference herein.

Other hull designs attempt to incorporate some of the advantages of a V-hull with the advantages of a flat bottom hull. Examples include U.S. Pat. No. 7,424,859 issued to Clancey and U.S. Pat. No. 6,125,781 issued to White, both of which are incorporated by reference herein. Although the prior art discloses that others have attempted to combine the advantages of a V-hull with those of a flat bottom hull, none have been successful in merging those two hull configurations into one commercially viable boat having more advantages from one hull type than disadvantages from the other. Common deficiencies in the prior art include lack of strength of the hull, few advantages associated with a certain hull style, and/or high cost of manufacturing, among others.

There is thus a need for a watercraft that overcomes the deficiencies of the prior art and is efficiently maneuverable in the water while providing increased fuel efficiency and a smooth, stable ride, even in rough and/or shallow water.

### SUMMARY OF THE INVENTION

The invention is directed to a universal depth boat and universal depth boat hull design that overcome the deficiencies of prior designs. The universal depth boat comprises a hull having a bow, stern, V-hull portion, flat bottom, keel, and first and second sides. The V-hull portion performs the wave-spreading function of the hull and is located at a forward portion adjacent the bow of the craft. The V-hull portion lends the universal depth boat greater stability and maneuverability over a bass boat. The flat bottom performs the wave riding function of the hull and is located at a rear portion adjacent the stern. The flat bottom allows the universal depth boat to be operated in extremely shallow waters compared to conventional V-hull boats.

The combination of a V-hull portion adjacent the bow and a flat bottom adjacent the stern allows the universal depth boat to perform in both deep and shallow waters while being extremely durable, stable, and maneuverable. The stern of the universal depth boat allows for single or dual motor mountings so that one motor may be used for operation in deep water and the other for operation in shallow water. The universal depth boat hull design allows the universal depth boat to traverse wing dams and even short spans of dry land in certain scenarios. The structure of the hull is designed to allow for stability and rapid turning in shallow or deep waters. The supporting structure components are on the interior of the hull, inside the boat—nothing is external to the hull providing a continuously smooth outer surface, which may be constructed of a single, unitary piece of material. A plurality of planes may be placed in the hull structure along the transition from the V-hull portion to the sides and/or the transition from the flat bottom to the sides through bending to increase the structural rigidity of the hull from the bow to the stern and affect the drag and stability of the universal depth boat as desired.

Applications for the universal depth boat include hunting, fishing, and recreation. The universal depth boat as disclosed allows waterfowl hunters to access areas that are inaccessible to other watercraft. When used for fishing, the universal depth boat provides fishermen with the ability to cross timbers and transverse marshy areas that would otherwise be inaccessible. The universal depth boat may also be used by emergency response crews because it gives such crews the ability to reach victims in traditionally inaccessible areas. Furthermore, the universal depth boat allows navigation of floodwaters having debris and unknown obstacles beneath the surface without fear of damage to the hull.

These and other advantages of the universal depth boat will become apparent to those skilled in the art in light of the present disclosure.

### BRIEF DESCRIPTION OF THE FIGURES

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limited of its scope, the invention will be described and explained with additional specificity and detail through the use of the accompanying drawings.

FIG. 1 provides a front perspective view of an exemplary embodiment of the universal depth boat.

FIG. 2 provides a rear perspective view of the exemplary embodiment of the universal depth boat.

FIG. 3 provides a detailed rear view of the exemplary embodiment of the universal depth boat.

FIG. 4 provides a detailed front view of the exemplary embodiment of the universal depth boat.

FIG. 5 provides a detailed top view of the exemplary embodiment of the universal depth boat.

FIG. 6 provides a top view of the hull from the exemplary embodiment of the universal depth boat before the various fingers are joined.

### DETAILED DESCRIPTION—LISTING OF ELEMENTS

| ELEMENT DESCRIPTION | ELEMENT # |
|---|---|
| Universal Depth Boat | 10 |
| V-Hull Portion | 11 |
| Flat Bottom | 12 |
| Keel | 13 |
| First Plane | 14a |
| Second Plane | 14b |
| Third Plane | 14c |
| Fourth Plane | 14d |
| Trim Tab | 15 |
| Stern | 16 |
| Bow | 17 |
| First Side | 18a |
| Second Side | 18b |
| Hull | 19 |
| First Top Rail | 21a |
| Second Top Rail | 21b |
| Cross Support | 22 |
| Longitudinal Support | 23 |
| Bow Cap | 24 |
| Stern Cap | 25 |
| Shelf | 26 |
| Deck | 28 |
| Finger | 29 |
| Floor Panel | 40 |
| Pod | 42 |

### DETAILED DESCRIPTION

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that phraseology and terminology used herein with reference to device or element orientation (such as, for example, terms like “front”, “back”, “up”, “down”, “top”, “bottom”, and the like) are only used to simplify description of the present invention, and do not alone indicate or imply that the device or element referred to must have a particular orientation. In addition, terms such as “first”, “second”, and “third” are used herein and in the appended claims for purposes of description and are not intended to indicate or imply relative importance or significance.

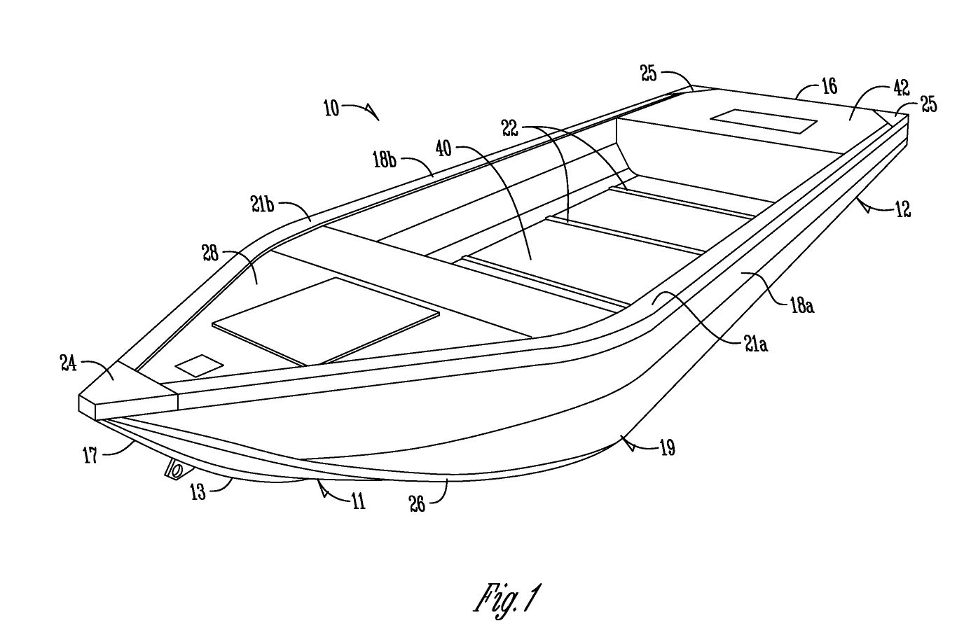

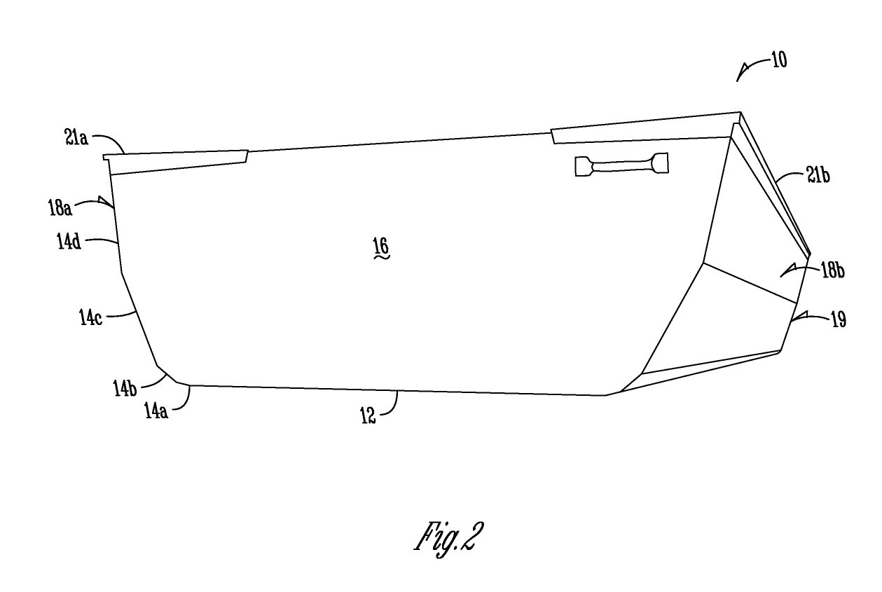

FIG. 1 provides a front perspective view of an exemplary embodiment of the universal depth boat 10. FIG. 2 provides a rear perspective view of the exemplary embodiment of the universal depth boat 10. As shown in FIGS. 1 and 2, the universal depth boat 10 includes a hull 19 with two main portions: a V-hull portion 11 adjacent the front of the universal depth boat 10 (i.e., the bow 17) and a flat bottom 12 adjacent the rear of the universal depth boat 10 (i.e., the stern 16, which may also be referred to as the transon). The stern 16 may be sized and configured so that an outboard marine motor (not shown) may be mounted thereto.

The hull 19 may be made of a single piece of material. As shown, the universal depth boat 10 has a full floatation hull 19 with the openness of a commercial-style hull 19. In the exemplary embodiment, the hull 19 has a lower rake angle to improve shallow water performance and provide improved planing characteristics. Accordingly, the universal depth boat 10 may be operated in extremely shallow water and plane out on the surface of the water at lower speeds as compared to conventional V-hull boats. The V-hull portion 11 of the hull 19 provides the user with greater ability to traverse waves and increases the stability of the universal depth boat 10 in open water and while turning.

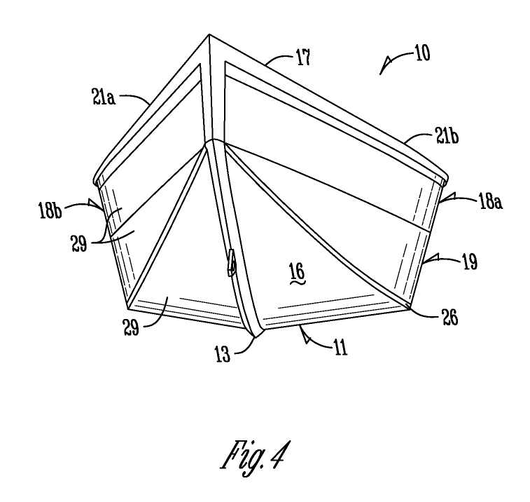

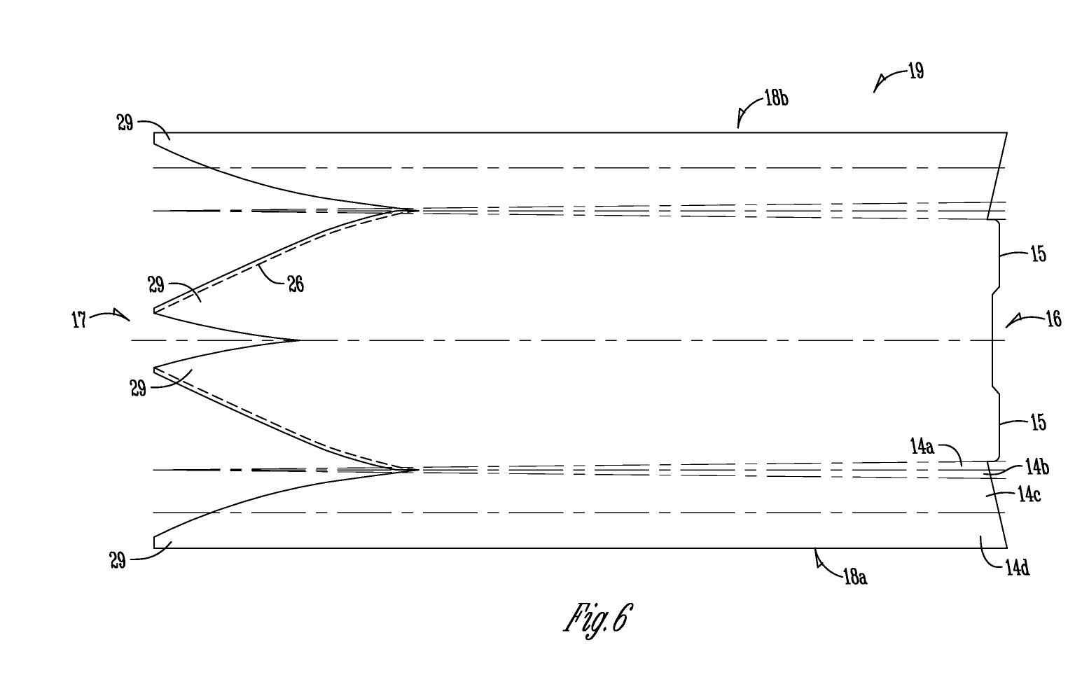

FIG. 6 shows the hull 19 outline for the exemplary embodiment of the universal depth boat wherein the hull 19 is constructed of a single piece of aluminum. Fingers 29 are cut into the aluminum sheet as shown in FIG. 6, and then the sheet is bent according to design specifications for form the hull 19. In the exemplary embodiment shown in FIG. 4, the hull 19 may include four planes 14a, 14b, 14c, and 14d in the transition from the flat bottom 12 to the first side 18a and second side 18b, respectively. From the flat bottom 12, the first plane 14a may be angled approximately nineteen degrees on both the first and second sides 18a, 18b. From the first plane 14a, the second plane 14b may be angled approximately twenty degrees on both the first and second sides 18a, 18b. From the second plane 14b, the third plane 14c may be angled approximately twenty degrees, and the fourth plane 14d may be angled approximately twenty degrees from the third plane 14c. The fourth plane 14d on each of the first and second sides 18a, 18b forms the upper-most portion of the sides of the hull 19. In certain embodiments, the fourth plane 14d at the area adjacent the stern 16 may be twenty to twenty four inches high depending on the length, width, and design specifications of the universal depth boat 10. The first and second sides 18a, 18b may be higher or lower in other embodiments depending on the requirements of the user.

The first and second planes 14a, 14b may intersect one another at the transition of the hull 19 from the flat bottom 12 to the V-hull portion 11. From this point of intersection, the first and second planes 14a, 14b may increase in width towards the stern 16 to aid the universal depth boat 10 in planing out on the water surface. At the stern, the width of the first and second planes 14a, 14b may be from one to twenty centimeters, depending on the application of the universal depth boat 10. The third and fourth planes 14c, 14d may terminate at their respective interfaces with the V-hull portion 11, as shown in FIG. 1. At the stern 16, the width of the third and fourth planes 14c, 14d may be from five to fifty five centimeters. In other embodiments not pictured herein, the universal depth boat 10 does not have first, second, and/or third planes 14a, 14b, 14c. Instead, the fourth plane 14d is adjacent the flat bottom 12, and the first and second sides 18a, 18b are formed exclusively from the fourth plane 14d. In such an embodiment, the hull 19 as viewed from the stern 16 would resemble a block-shaped “U”.

In another embodiment not pictured herein, the universal depth boat 10 has first a plane 14a and a fourth plane 14d, but does not have second or third planes 14b, 14c. The various angles, dimensions, and/or absence of various planes 14a, 14b, 14c, 14d in no way limits the scope of the universal depth boat 10. The universal depth boat 10 may include any combination of planes 14a, 14b, 14c, and/or 14d at any orientation with respect to one another, the flat bottom 12, and the V-hull portion 11. Furthermore, the vertical distance from the interface of the flat bottom 12 to the V-hull portion 11 to the top rails 21a, 21b will vary depending on the specific application of the universal depth boat 10 and in no way limits the scope of the present invention. Those skilled in the art will recognize that this vertical distance affects the stability of the universal depth boat 10 and the minimum depth of water in which it will operate.

The overall length of the universal depth boat 10, the length and width of the V-hull portion 11, the length and width of the flat bottom 12, and the weight of the universal depth boat 10 may vary depending on the specific application. The preceding design factor coupled with the presence or absence, dimensions, and orientation of planes 14a, 14b, 14c, 14d in the hull 19 affect the stability, maneuverability, and minimum depth of water required for operation of the universal depth boat 10. For example, the distance from bow 17 to stern 16 may be as little as six feet or as much as twenty four feet, or it may be some value outside of that range. The width of the stern 16 may be as little as two feet or as much as eight feet, or it may be some value outside that range. Accordingly, an infinite number of orientations and configurations will be apparent to those skilled in the art within the spirit and scope of the present invention.

After the desired planes 14a, 14b, 14c, and/or 14d are fashioned into the hull 19, the V-hull portion 11 may be formed. The various fingers 29 shown in FIG. 6 are brought together and joined to form the V-hull portion 11. The fingers 29 may be joined by any method known to those skilled in the art that is appropriate for the material used in the hull 19. For example, if the hull 19 is made of aluminum, the fingers 29 may be welded; if the hull 19 is made of a polymer material, the fingers 29 may be chemically or thermally fused. A keel 13 may be affixed to the center line of the V-hull portion 11 to increase strength and rigidity of the universal depth boat 10. As with joining the fingers 29, the keel 13 may be affixed to the hull 19 in any manner known to those skilled in the art that is appropriate for the materials of construction. As shown herein, a shelf 26 may be fashioned in the V-hull portion 11 along the interface of two fingers 29 on each side of the universal depth boat 10. The shelf 26 serves to deflect water or other material from entering the interior of the universal depth boat 10.

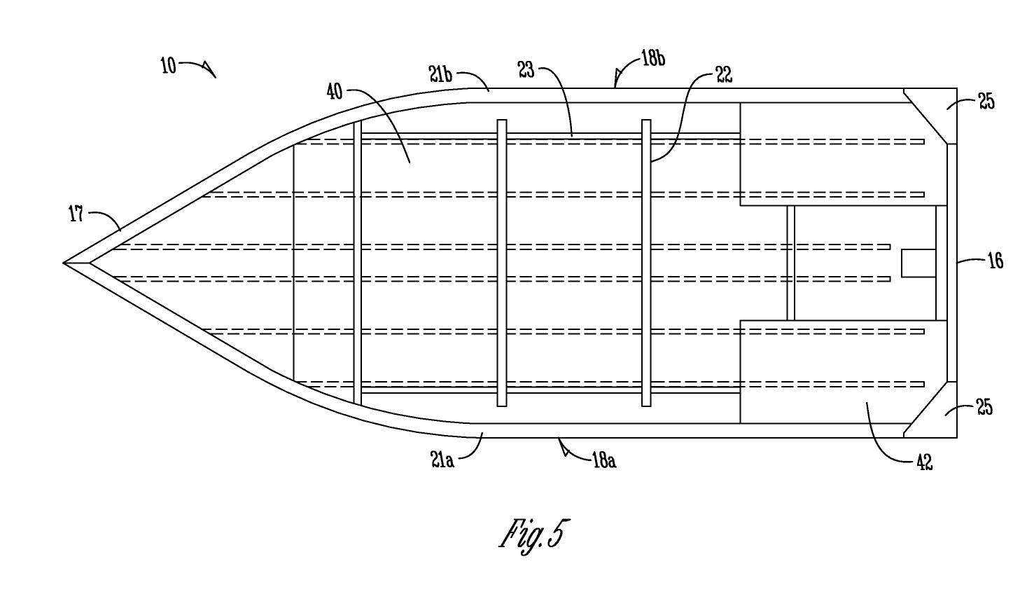

A first top rail 21a is placed on the top surface of the fourth plane 14d on the first side 18a, and a corresponding second top rail 21b is placed on the top surface of the fourth plane 14d on the second side 14b in the exemplary embodiment. To increase the strength and structural rigidity of the universal depth boat 10, a plurality of cross supports 22 and longitudinal supports 23 may be affixed to the interior surface of the hull 19, as shown in FIG. 5. For additional strength, a bow cap 24 may be affixed to the bow 17 and first and second top rails 21a, 21b. Additionally, two stern caps 25 may be affixed to the first and second sides 18a, 18b and the stern 16, respectively. The materials of construction, number, and orientation of the cross supports 22, longitudinal supports 23, bow cap 24, and stern caps 25 will vary depending on the specific application of the universal depth boat 10. The universal depth boat 10 is designed so that stresses and forces are transferred across the entire hull 19 to prevent hooking and flexing.

Floor panels 40 may be placed over or around the cross supports 22 and longitudinal supports 23 so that the universal depth boat 10 has a flat floor for occupants. Additionally, seating structures, such as pods 42, may be placed over the cross supports 22 and/or longitudinal supports 23, or pods 42 may be placed directly onto floor panels 40 at convenient locations. Additionally, a deck 28 may be positioned between the first and second top rails 21a, 21b near the bow 17 for added strength or simply to create additional storage space protected from the elements in the area underneath the deck 28. The materials of construction, number, and orientation of the floor panels 40, pods 42, and or decks 28 will vary depending on the specific application of the universal depth boat 10 and therefore are not limiting.

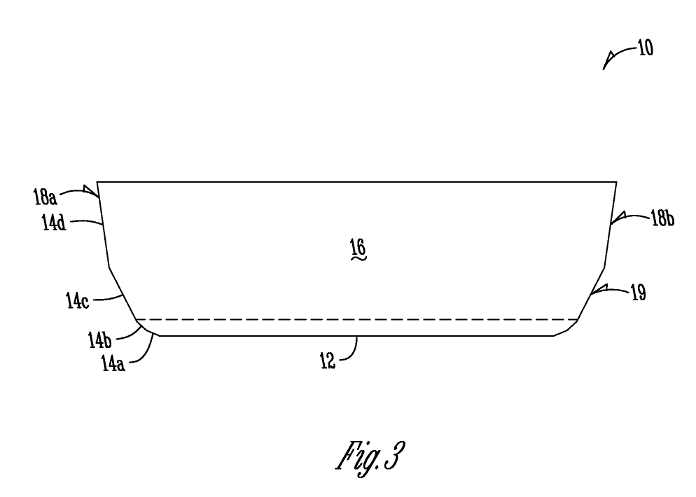

As shown in the exemplary embodiment pictured herein (best shown in FIGS. 2-3, a trim tab 15 may be placed at the interface of the flat bottom 12 and the stern 16. The trim tab 15 may be integrally formed with either the flat bottom 12 or the stern 16, or it may be separately affixed thereto. As is well known to those skilled in the art, the trim tab 15 may be used to adjust the angle of the universal depth boat 10 with respect to the water surface at a given speed by adjusting the angle of the trim tab 15 relative to the flat bottom 12.

In another embodiment not pictured herein, the universal depth boat 10 may include runners (not shown) affixed to the exterior portion of the hull 19. The runners (not shown) may be shaped as a fin and extend a predetermined distance from the surface of the hull 19. The runners (not shown) aide in cornering and maneuverability, and may be constructed of any suitable material, such as aluminum, wood, polymers, etc. The runners (not shown) may be affixed to the hull 19 by any means suitable for the materials of construction that is known to those skilled in the art. It is contemplated that two runners each placed approximately one foot from their respective sides 18a, 18b extending approximately ten feet from the stern along the flat bottom 12, and approximately extending one inch from the surface of the hull 19 would provide increased maneuverability in many situations. However, other configurations and/or dimensions of runners (not shown) may be used without departing from the spirit and scope of the present invention.

The universal depth boat 10 and the various elements thereof may be constructed from aluminum with a single-piece formed hull 19 as described above, or from multiple sheets of material with welded seams therebetween. In one embodiment, the hull 19 is constructed from 0.125 inch thick marine-grade aluminum and is one piece. All supports and structures may be welded to one another. Alternatively, riveting may be used to attach certain elements to one another, such as floor panels 40, bow cap 24, and the like. The stern 16 is typically constructed from a strong material capable of supporting the weight of an outboard marine engine from two to one hundred and fifty horsepower. This may be a thick aluminum or other material known to those skilled in the art, such as steel, metallic alloy, wood, polymeric material, etc. The hull 19 and other portions of the universal depth boat 10 may be fabricated from materials other than aluminum, such as, for example, fiberglass reinforced plastic, high-density polyethylene, high-strength polymers, or other suitable materials.

As will be apparent to those of ordinary skill in the art, the universal depth 10 boat may be equipped with a wide range of accessories and options including multiple seats, accessory lights and racks, accessory electrical plugs, winch mounts, extended deck storage, onboard fuel tanks, lockable storage spaces, stern 16 cutouts for specific motors, or any other accessory known to those skilled in the art for use with boats. The inclusion or exclusion of any accessory items in no way limits the scope of the universal depth boat 10.

It should be noted that the present invention is not limited to the specific embodiments pictured and described herein, but is intended to apply to all similar boats with a hull 19 having a V-hull portion 11 and a flat bottom 12. Modifications and alterations from the described embodiments will occur to those skilled in the art without departure from the spirit and scope of the present invention.

What is claimed is:

1. A universal depth boat hull for allowing a boat to travel in nearly any depth of water, comprising:
a bow;
a stern;
a first and second side, said first side and said second side being connected to the bow and the stern on opposite sides thereof;
a flat bottom adjacent the stern, the flat bottom extending from the first side to the second side; and
a V-hull portion at the bow between the first and second sides.

2. The boat hull of claim 1 further comprising a keel in the center of the V-hull portion.

3. The boat hull of claim 1 further comprising at least one shelf positioned at and extending from the V-hull portion adapted to deflect water from the V-hull portion.

4. The boat hull of claim 1 wherein said first and second sides of said hull further comprise a first plane oriented at an angle between five and forty-five degrees above the flat bottom.

5. The boat hull of claim 4 wherein said first and second sides of said hull further comprise a second plane oriented at an angle between five and forty-five degrees above the first plane.

6. The boat hull of claim 5 wherein said first and second sides of said hull further comprise a third plane oriented at an angle between five and forty-five degrees above the second plane.

7. The boat hull of claim 6 wherein said first and second sides of said hull further comprise a fourth plane oriented at an angle between five and forty-five degrees above said third plane.

8. The boat hull of claim 7 wherein said first and second planes increase in width from said bow to said stern.

9. The boat hull of claim 1 wherein the bow, stern, first side, second side, flat bottom, and V-hull portion comprise a single piece of material.

10. The boat hull of claim 9 wherein the material is aluminum.

11. A universal depth boat configured to operate in a universal depth of water, comprising:
a boat hull, the boat hull comprising a bow, a stern, a first and second side, said first side and said second side being connected to the bow and the stern on opposite sides thereof, a flat bottom adjacent the stern, the flat bottom extending from the first side to the second side, and a V-hull portion at the bow between the first and second sides;
a first and second top rail, the first top rail affixed to the first side, the second top rail affixed to the second side, and wherein said first and second top rails terminate adjacent said bow at a point with said V-hull portion; and
a bow cap, wherein said bow cap connects said first and second top rails adjacent said bow.

12. The boat of claim 11 further comprising a plurality of cross supports extending from the inside of first side to the inside of the second side.

13. The boat of claim 12 further comprising a plurality of longitudinal supports extending from the inside of the stern to the inside of the bow, the longitudinal supports being generally perpendicular to the plurality of cross supports.

14. The boat of claim 13 further comprising a plurality of stern caps mounted at the stern adjacent the first and second top rail.

15. The boat of claim 14 further comprising a plurality of floor panels at the plurality of cross and longitudinal supports.

16. The boat of claim 15 further comprising at least one pod positioned between the first and second sides of the boat.

17. The boat of claim 16 further comprising a trim tab extending generally rearwardly from the stern at the connection of the stern and the flat bottom.

18. A method of forming a boat hull for use in a nearly universal depth of water, comprising:
providing a single piece of material;
forming fingers at a bow end of the single piece of material;
bending the single piece of material at predetermined positions to form a first and second side and a flat bottom portion at a stern end of the single piece of material; and
connecting the plurality of fingers to one another to form a V-hull portion at the bow end of the single piece of material.

19. The method of claim 18 further comprising attaching a stern to the first side, second side, and the flat bottom portion of the single piece of material to close the stern end of the hull.

20. The method of claim 18 wherein the first and second sides each include a first plane, a second plane, a third plane, and a fourth plane.
